(19) United States
(12) Patent Application Publication
(10) Pub. No.: US 2026/0205957 A1
(43) Pub. Date: Jul. 16, 2026

(54) ADJUSTING PROXIMITY THRESHOLDS WHEN DEVICES ARE CONTAINED IN CASES

(71) Applicant: Google LLC, Mountain View, CA (US)

(72) Inventors: Gregory Black, Vernon Hills, IL (US); Andrew Peter Pavacic, Chicago, IL (US); Vijay L. Asrani, San Jose, CA (US); Hongming Zhao, Mountain View, CA (US)

(21) Appl. No.: 19/136,733

(22) PCT Filed: Dec. 16, 2022
(86) PCT No.: PCT/US2022/081739

§ 371 Date: Jun. 6, 2025

(51) Int. Cl. H04W 52/28; H04W 52/36

(52) U.S. Cl. CPC H04W 52/283; H04W 52/367

(57) ABSTRACT

In general, techniques are described that are directed to a device comprising an antenna, a radio, and processing circuitry. The radio may wirelessly communicate data, via the antenna. The processing circuitry may determine whether the device is contained within a case, and responsive to determining that the device is contained within the case, select a first proximity threshold as a current proximity threshold by which to determine whether a user is proximate to the device. The first proximity threshold may be different than a second, proximity threshold used responsive to determining that the device is not contained within the case. The processing circuitry may next cause, based on the selected proximity threshold, the radio to configure either a first transmission power or a second transmission power as a current transmission power. The radio may wirelessly communicate the data via the antenna using the current transmission power.

### BACKGROUND

Devices, such as smartphones, tablet computers, smart glasses, smart watches, laptops, and the like, are increasingly employing wireless communication to interface with networks, such as wireless local area networks (WLAN), personal area networks (PANs), cellular networks, etc., and/or directly with other devices via near field communication (NFC), ultra-wideband (which may refer to UWB, ultra wideband, ultra-wide band and ultraband), or other direct wireless communication platforms. These devices are produced in a wide range of different form factors that are regulated, dependent on the form factor and user proximity to the devices, to reduce user exposure to radio frequencies (RF) emitted by radios for transmitting and/or receiving data via wireless communication.

The regulations may specify specific absorption ratios (SARs) for different form factors of the devices. For example, a tablet with a display and overall diagonal dimension exceeding 20 centimeters may be subject to the tablet SAR test procedure with a test separation distance of zero millimeters; while a tablet with a display and overall diagonal dimension less than 20 centimeters is subject to the mini-tablet SAR test procedure with a test separation distance of 5 or 10 millimeters. These devices may include a power controller designed to configure the radios according to various power tables that meet these regulations, which are certified by various governments around the world.

In order to meet the regulations, the devices may include a proximity sensor (e.g., a presence-sensitive display) configured to determine a relative proximity of the user to the devices. The power controller may receive the proximity of the user to the device and configure the radio according to a power table that limits the radio power when the user is proximate to the device (e.g., within millimeters of the presence-sensitive display). However, various factors may impact the ability of the devices to accurately determine the proximity of the user to the device. To ensure compliance with the regulations, the devices are commonly designed with the strictest power levels that adhere to compromised proximity detection.

### SUMMARY

According to examples of the disclosed subject matter, processing circuitry in a device may be configured to implement a power controller that adapts radio states (e.g., a power level) of a radio according to a determination of whether a proximity sensor is impacted by various factors, such as whether the device is contained within a case. The processing circuitry may interface with various sensors to detect the various factors that may impact the proximity sensor. The processing circuitry may then select various thresholds for determining whether the device is proximate to a user in order to better adjust the radio states for the radio, adjusting power levels to accommodate the specific absorption rates (SARs) specified by government regulations.

In the example of cases (e.g., a protective case), the processing circuitry may receive proximities that are reduced given that a proximity sensor (e.g., a presence-sensitive display) of the device may be impacted by the case. That is, the proximity sensor may sense proximity using capacitance and the case may reduce the amount of capacitance sensed. The processing circuitry may determine that the device is contained within the case and select potentially lower proximity thresholds for detecting whether the user is proximate to the device. When the processing circuitry determines that the device is not contained in the case, the processing circuitry may select potentially higher proximity thresholds (relative to when the processing circuitry determines that the device is contained in the case) for detecting whether the user is proximate to the device. While described with respect to lower and higher proximity thresholds for certain conditions (e.g., in the case or not in the case), in some instances a higher proximity threshold may be used when the processing circuitry determines that the device is not contained in the case and lower proximity thresholds when the processing circuitry determines that the device is contained in the case.

In this respect, various aspects of the techniques may enable the processing circuitry of the device to better detect proximity of the user to the device and adjust radio states of the radio more accurately to provide better wireless communication (e.g., without exceeding various SARs specified by government regulations). Rather than resort to proximity thresholds that accommodate reduced proximity detection in all device states, the processing circuitry may adapt proximity thresholds based on a current state (e.g., contained in or not contained in the case) of the device, thereby potentially enabling the processing circuitry to more accurately configure the radio state (e.g., transmission power level) of the radio.

Through potentially more accurate radio state configuration, the device itself may function more efficiently (e.g., in terms of performing wireless communication more reliably with higher signal-to-noise ratios—SNRs, reduced data drops and/or corruption, etc.) and provide a better user experience in terms of more reliable wireless communication, while also adhering to government regulations regarding SARs for wireless communication.

In one example, various aspects of the techniques are directed to a device comprising: an antenna; a radio configured to wirelessly communicate data via the antenna; and processing circuitry configured to: determine whether the device is contained within a case; responsive to determining that the device is contained within the case, select a first proximity threshold as a current proximity threshold by which to determine whether a user is proximate to the device, the first proximity threshold different than a second proximity threshold used responsive to determining that the device is not contained within the case; and cause, based on the selected proximity threshold, the radio to configure either a first transmission power or a second transmission power as a current transmission power, wherein the radio wirelessly communicates the data via the antenna using the current transmission power.

In another example, various aspects of the techniques are directed to a method comprising: determining, by processing circuitry of a device, whether the device is contained within a case; responsive to determining that the device is contained within the case, selecting, by the processing circuitry, a first proximity threshold as a current proximity threshold by which to determine whether a user is proximate to the device, the first proximity threshold different than a second proximity threshold used responsive to determining that the device is not contained within the case; based on the selected proximity threshold, cause, by the processing circuitry, a radio of the device to configure either a first transmission power or a second transmission power as a current transmission power; and wirelessly communicate, by the radio and via an antenna, data using the current transmission power.

In another example, various aspects of the techniques are directed to a non-transitory computer-readable storage medium having instructions stored thereon that, when executed, cause one or more processors of a device to: determine whether the device is contained within a case; select, responsive to determining that the device is contained within the case, a first proximity threshold as a current proximity threshold by which to determine whether a user is proximate to the device, the first proximity threshold different than a second proximity threshold used responsive to determining that the device is not contained within the case; and cause, based on the selected proximity threshold, a radio of the device to configure either a first transmission power or a second transmission power as a current transmission power by which to communicate data via an antenna.

In another example, various aspects of the techniques are directed to an apparatus comprising: means for determining whether the device is contained within a case; responsive to determining that the device is contained within the case, means for selecting a first proximity threshold as a current proximity threshold by which to determine whether a user is proximate to the device, the first proximity threshold different than a second proximity threshold used responsive to determining that the device is not contained within the case; based on the selected proximity threshold, means for causing a radio of the device to configure either a first transmission power or a second transmission power as a current transmission power; and wirelessly communicate, by the radio and via an antenna, data using the current transmission power.

Additional features, advantages, and embodiments of the disclosed subject matter may be set forth or apparent from consideration of the following detailed description, drawings, and claims. Moreover, it is to be understood both the foregoing summary and the following detailed description are illustrative and are intended to provide further explanation without limiting the scope of the claims.

### BRIEF DESCRIPTION OF THE DRAWINGS

FIG. 1 is a block diagram illustrating a representation of a foldable mobile device in accordance with examples of the present disclosure.

FIG. 2 is a block diagram illustrating another representation of a foldable mobile device in accordance with examples of the present disclosure.

FIG. 3 is a flowchart illustrating example operation of foldable mobile device of FIG. 1 in performing proximity threshold adjustments in accordance with various aspects of the techniques described in this disclosure.

FIG. 4 is a flowchart illustrating example operation of foldable mobile device of FIG. 2 in performing proximity threshold adjustments in accordance with various aspects of the techniques described in this disclosure.

### DETAILED DESCRIPTION

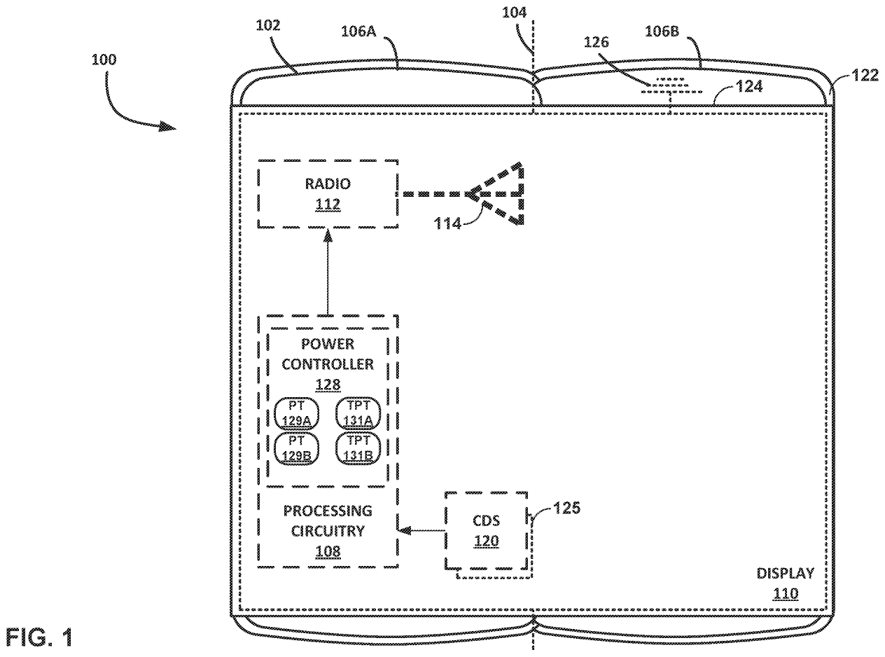

FIG. 1 is a block diagram illustrating a representation of a foldable mobile device 100 in accordance with various aspects of the techniques described in this disclosure. Foldable mobile device 100 may represent any type of device capable of folding along an axis 104, including along a centered axis or an off-center axis. While described herein with respect to foldable mobile device 100, any type of device capable of performing factor-based adaptation of wireless communication may be configured according to the techniques described in this disclosure. Examples of such devices may include a mobile phone (including a so-called “smartphone”), smart glasses, a smart watch, a portable speaker (including a portable smart speaker), a laptop computer, a portable gaming system, a wireless gaming system controller, and the like.

Foldable mobile device 100 may include a housing 102 having a hinge or other element that enables folding along an axis 104, having a first half 106A and a second half 106B. Housing 102 may be formed from most any material such as metal (including aluminum), plastics (including most any polymer), glass, carbon fiber, etc. along with combinations of the materials in which first half 106A may have different or the same materials as second half 106B. While described with respect to “halves”, foldable mobile device 100 may include a first portion and a second portion that are not equal or otherwise of approximately (within manufacturing tolerances) the same size. As such, first half 106A may be a different size, in some examples, compared to second half 106B, where first half 106A may only cover, when folded along axis 104, a portion of second half 106B (and not cover nearly the entirety of second half 106B).

Foldable mobile device 100 may include processing circuitry 108, a display 110, a radio 112, an antenna 114, as well as other components and/or circuitry (which are not shown in the example of FIG. 1 for ease of illustration purposes), such as global positioning system (GPS) electronics, accelerometers, gyroscopes, audio processing circuitry (e.g., a headphone jack and accompanying circuitry), one or more speakers, light emitting diodes (LEDs), one or more cameras, and the like.

Processing circuitry 108 may represent circuitry configured to support operation of foldable mobile device 100 and may execute software (or, in other words, a set of instructions) that may enable execution of hierarchical software layers to present various functionalities for use by a user. Processing circuitry 108 may, for example, execute a kernel forming a base layer by which an operating system may interface with various other processing units, such as a camera, microphones, sensors (possibly including display 110), etc. Processing circuitry 108 may also execute the operating system which presents an application space in which one or more applications (e.g., first party and/or third party applications) may execute to present graphical user interfaces with which to interact with the user.

Processing circuitry 108 may include one or more of a microprocessor, a controller, a digital signal processor (DSP), a central processing unit (CPU), a graphics processing unit (GPU), an application specific integrated circuit (ASIC), a field-programmable gate array (FPGA), or equivalent discrete or integrated logic circuitry. The functions attributed to processing circuitry 108 in this disclosure may be embodied as software (as noted above), firmware, hardware and combinations thereof. Although example foldable mobile device 100 of FIG. 1 is illustrated as including one processing circuity 108, other example foldable mobile devices according to this disclosure may include multiple processors (or multiple so-called “cores,” which is another way to refer to processors when packaged together) configured to execute one or more functions attributed to processing circuitry 108 of foldable mobile device 100 individually or in different cooperative combinations.

Display 110 may represent a device configured to emit light via an array of pixels and thereby output an image or a sequence of images (e.g., video). Display 110 may include one or more of a liquid crystal display (LCD), dot matrix display, light emitting diode (LED) display, organic light-emitting diode (OLED) display, touch screen, e-ink, or similar monochrome or color display capable of providing visible information to users of foldable mobile device 100. Display 110 may provide a user interface related to functionality provided by foldable mobile device 100. Display 110 may include a presence-sensitive display and/or touch-sensitive display that may enable interactions with a graphical user interface presented by display 110.

Although shown as a single display, display 110 may represent one or more displays. In some examples, display 110 may represent a single display capable of folding along axis 104. In other examples, display 110 may represent two displays, where one display is housed within half 106A and another display is housed within half 106B. When two or more displays are included in device 100, each of the displays may operate to present a continuous user interface or separate user interfaces. As such, various aspects of the techniques may enable foldable mobile device 100 to operate with a single display or multiple displays.

Radio 112 may represent one or more communication devices capable of wirelessly (meaning without fixed wires) transmitting data via antenna 114 using electromagnetic waves having designated (and often regulated) frequency spectrums. Radio 112 may conform to various standards defined for different communication purposes, where such standards may support wireless local area networks (WLANs) per, as one example, the Institute of Electrical and Electronics Engineers (IEEE) 802.1 suite of standards, cellular networks (which may also be referred to as mobile networks) promulgated by standards, as an example, from the 3^{rd}Generation Partnership Project (3GPP)™, personal area networks (PANs) set forth, e.g., by the Bluetooth® special interest group, etc.

Radio 112 may also represent one or more communication devices developed for direct wireless communication (where direct means such communication occurs without establishing various network stacks). Examples of such direct networks include near-field communication (NFC), which involves direct inductive coupling between two so-called antennas present on NFC enabled devices, radio-frequency identification (RFID) that uses electromagnetic fields to automatically identify and track tags, ultra-wideband (which may refer to UWB, ultra wideband, ultra-wide band and ultraband), etc.

Radio 112 may communicate data wireless through various manipulations (e.g., modulation of phase and gain of signals over time and/or frequency) of electromagnetic waves that induce a current in receiving antennas, such as antenna 114, Antenna 114 may represent a transducer (composed of conductors) that is capable of transmitting and receiving data through such induction. Antenna 114 may represent an array of one or more conductors electrically connected to radio 112 (which may also be referred to as a transmitter/receiver, or as a transceiver). Radio 112 may transmit electrical signals via antenna 114, which outputs the signals as electromagnetic waves that a receiving antenna captures. Radio 112 may receive similar electromagnetic waves via antenna 114, amplifying (and usually filtering as well as performing other forms of translation) the resulting electrical signals to recover the data.

As described above, radio 112 may wirelessly transmit and receive data in the form of electromagnetic waves modulated at certain frequencies referred to as radio frequencies (RF). As an example, the radio frequencies for various cellular standards may range one gigahertz (1 GHz) to as high as 40 GHz for various cellular standards. As another example, the radio frequencies for various WLAN standards may range from 2.4 GHz up to 6 GHz. These frequency bands are typically regulated by various governments via promulgated regulations that dictate how the frequency bands can be used by various devices, including foldable mobile device 100.

One aspect of these regulations dictates how such devices are able to power radio 112, dependent on the form factor and user proximity to the devices, to reduce user exposure to the radio frequencies emitted by radios for transmitting and/or receiving data via wireless communication. User exposure is generally measured at a particular distance from the device (that may vary based on the device form factor while powering radio 112) as a specific absorption ratio (SAR).

That is, the regulations may specify specific absorption ratios (SARs) for different form factors of the devices. A tablet, for example, may include a display with a diagonal dimension that exceeds 20 centimeters, and the regulations may require the tablet to meet a first set of SARs at a measurement distance of zero millimeters. A smartphone that includes a display with a diagonal dimension that is less than 20 centimeters may be designed to meet a second different set of SARs at a measurement distance of five or 10 millimeters. These devices may include a power controller (which is shown as a power controller 128 for foldable mobile device 100) designed to configure the radios (such as radio 112) according to various powers (e.g., power tables) that meet these regulations, which are certified by various governments around the world.

In order to meet the regulations, foldable mobile device 100 may include a proximity sensor (e.g., presence-sensitive display 110) configured to determine a relative proximity of the user to foldable mobile device 100. Power controller 128 may receive the proximity of the user to foldable mobile device 100 and configure radio 112 according to a power that limits the radio power when the user is proximate to the device (e.g., within millimeters of presence-sensitive display 110). Limiting the power may limit exposure to radio frequencies, but may also reduce a distance that wireless communication can be successfully performed. This reduced distance may prevent wireless communication in some instance, which detracts from the user experience especially as an increasing amount of data is sent wirelessly and often involves some form of wireless communication to support backend operation of devices (e.g., some processing may be offloaded to cloud-based servers).

As noted above, tablet devices or foldable devices, such as foldable mobile device 100 that may represent a tablet when in the open or unfolded state, may be required to meet the more stringent tablet based regulations noted above (SAR being measured at 0 millimeters as opposed to the 5 or 10 millimeters for smaller mini-tablet or so-called “phablet” devices). In this respect, foldable mobile device 100 may have to accurately determine a number of different factors, such as whether foldable mobile device 100 is in motion, whether foldable mobile device 100 is in an open or closed state (or, in other words, a folded or unfolded state), and proximity of the user to foldable mobile device 100.

However, various factors may impact the ability of presence sensitive display 110 to accurately determine the proximity of the user to foldable mobile device 100. To ensure compliance with the regulations, such devices are commonly designed with the strictest power levels that adhere to compromised proximity detection. In other words, power controller 128 may set proximity thresholds that assumes inaccurate proximity, erring on the side of reduced powers (which may also be referred to as transmission power tables) for a lower determined user proximity to ensure that SARs are maintained by foldable mobile device 100.

In accordance with various aspects of the techniques described in this disclosure, processing circuitry 108 may be configured to implement power controller 128 that adapts radio states (e.g., a power level) of a radio according to a determination of whether a proximity sensor (represented by presence sensitive display 110 in the example of FIG. 1, which may also be referred to as proximity sensor 110) is impacted by various factors, such as whether foldable mobile device 100 is contained within a case. The case in the example of FIG. 1 is shown as case 122 that includes a screen protector 124. Processing circuitry 108 may interface with various sensors, such as a case detection sensor (CDS) 120, to detect the various factors that may impact proximity sensor 110. Power controller 128 may then select various thresholds for determining whether foldable mobile device 100 is proximate to a user in order to better adjust the radio states for radio 112, adjusting power levels to accommodate the specific absorption rates (SARs) specified by government regulations.

In the example of case 122 (which may also be referred to as a protective case), power controller 128 may receive proximities that are adjusted given that proximity sensor 110 of foldable mobile device 100 may be impacted by case 122. That is, proximity sensor 110 may sense proximity using capacitance and case 122 may reduce the amount of capacitance sensed. This is a function of how proximity sensor 110 measures capacitance between antenna 114 and an electrical ground 126, where case 122 (whether or not case 122 includes screen protector 124) reduces the amount of physical contact by the user directly with foldable mobile device 100 and thereby reduces sensed capacitance.

Rather than compare the sensed proximity (which is another way to refer to sensed capacitance) to the strictest threshold (or in other words, the lowest threshold for detecting a proximal user), power controller 128 may receive an indication of whether foldable mobile device 100 is contained within case 122. As noted above, foldable mobile device 100 may include CDS 120. CDS 120 may represent any configuration of one or more sensors used to detect whether foldable mobile device 100 is contained within a case.

In some instances, CDS 120 may include a Hall sensor located within foldable mobile device 100 at a location adjacent to case 122. Case 122 may include a case detection module 125 (that represents, in this instance, a magnet) that emits a magnetic field that CDS 120 may detect in order to facilitate detection of case 122. In other examples, CDS 120 may include a RFID tag reader that reads case detection module 125 (which, in this instance, represents an RFID tag) that CDS 120 may inspect to facilitate detection of case 122. RFID may enable anti-spoofing capabilities as only verified RFID tag information may enable case detection, thereby potentially providing more security that ensures proper radio power states for tested and verified protective cases that adhere to regulated specific absorption rates. In other instances, CDS 120 may represent a presence-sensitive display 110 (e.g., which represents a part of or all of display 110) that CDS 120 may analyze based on user interactions (e.g., in terms of capacitive feedback) to detect case 122, as described in more detail below.

While described above as providing anti-spoofing capabilities with respect to RFID tags, any type of authenticatable information can be conveyed using other transmission means to verify that the case is a tested and verified case (or, in other words, a valid case), such as scanning, using a camera, a QR code or other type of symbol or bar code, entering a code from a text, email or other message after registering the case, using NFC, etc. In this way, CDS 120 may determine whether the case is a valid case that has been tested with respect to the radio with the first power transmission power table and the second power transmission power table to verify SARs, and determine, responsive to determining that the case is the valid case, that the device is contained in the valid case. CDS 120 may therefore provide anti-spoofing to prevent untested and unverified cases from being detected as cases for which regulated SARs can be achieved using various aspects of the techniques described in this disclosure. Responsive to not detect the case as valid, CDS 120 may not cause radio 112 to use the lower PT 129A.

Power controller 128 may determine that foldable mobile device 100 is contained within case 122 and select lower proximity thresholds for detecting whether the user is proximate to foldable mobile device 100. When power controller 128 determines that foldable mobile device 100 is not contained in case 122, power controller 128 may select higher proximity thresholds (relative to when power controller 128 determines that foldable mobile device 100 is contained in case 122) for detecting whether the user is proximate to foldable mobile device 100. While described with respect to lower and higher proximity thresholds for certain conditions (e.g., in the case or not in the case), in some instances a higher proximity threshold may be used when the processing circuitry determines that the device is not contained in the case and lower proximity thresholds when the processing circuitry determines that the device is contained in the case.

For example, if the proximity sensor is a capacitive sensor then the protective case may increase the capacitance. For a given triggering distance the on-body and off-body capacitive reading would both be higher when there is a case, which suggests that the first proximity threshold (used when there is not a case) may be lower. However, the proximity sensor may represent an auto-zeroing capacitive sensor, whereby the off-body capacitance gets set to zero, in which case the proximity sensor measures the difference between on-body and off-body capacitance, and for a given triggering distance, the first proximity threshold (used when there is not a case) might be higher or lower. However, the threshold does not determine a fixed triggering distance, but rather the distance that causes SAR to go above a regulatory limit, which tends to decrease when there is a case. A lower threshold may correspond to a higher triggering distance. In this instance, decreasing triggering distance due to the case would cause the first proximity threshold (used when there is not a case) to be potentially higher. The first proximity threshold may therefore be higher or lower than the second proximity threshold depending on various factors including proximity sensor type and the effect of the case on SAR In operation, power controller 128 may determine whether foldable mobile device 100 is contained within case 122. That is, power controller 128 may interface with CDS 120 to determine, in one or more of the ways noted above (e.g., magnetic field detection, RFID tag inspection, via sensed capacitance from proximity sensor 110, etc.), whether foldable mobile device 100 is contained within case 122. Responsive to determining that foldable mobile device 100 is contained within case 122, power controller 128 may select a first proximity threshold (PT) 129A (“PT 129A”) as a current proximity threshold by which to determine whether the user is proximate to foldable mobile device 100.

PT 129A may be different (which is assumed to be less, but may be either higher or lower per the above factors, including proximity sensor type and the effect of the case on SAR) than a second proximity threshold, shown as “PT 129B” in the example of FIG. 1, used responsive to determining that foldable mobile device 100 is not contained within case 122. Although described in this example as being less than PT 129B, PT 129A may be greater than PT 129B for different configurations of proximity sensor 110 (e.g., proximity sensors that utilize actual distances, such as radar, etc.). However, in the example of the capacitive sensing proximity sensor described above with respect to presence-sensitive display 110, proximity is defined relative to detected capacitance and case 122 may reduce sensed capacitance resulting in lower PT 129A relative to PT 129B used when case 122 is not detected. In any event, in response to determining that foldable mobile device 100 is not contained within case 122, power controller 128 may select PT 129B as the current proximity threshold.

Based on the selected proximity threshold, power controller 128 may interface with radio 112 to configure either a first transmission power table (TPT) 131A (“TPT 131A”) or a second TPT 131B as a current transmission power table. That is, power controller 128 may interface (e.g., interrupt driven, periodic polling, etc.) with proximity sensor 110 to determine a current proximity of the user to foldable mobile device 100. Power controller 128 may compare the current proximity to the selected proximity threshold (which, for purposes of example, is assumed to be PT 129A). When the current proximity exceeds the selected proximity threshold, power controller 128 may configure radio 112 to use TPT 131A. When the current proximity does not exceed the selected proximity threshold, power controller 128 may configure radio 112 to use TPT 131B. Radio 112 may then wirelessly communicate data via antenna 114 using the current transmission power table (either TPT 131A or TPT 131B).

In this respect, various aspects of the techniques may enable processing circuitry 108 of foldable mobile device 100 to better detect proximity of the user to foldable mobile device 100 and adjust radio states of radio 112 (e.g., using TPTs 131A or 131B) more accurately to provide better wireless communication without exceeding various SARs specified by government regulations. Rather than resort to proximity thresholds that accommodate reduced proximity detection in all states of foldable mobile device 100 (e.g., open/closed, uncased/cased, etc.), processing circuitry 108 may adapt proximity thresholds (e.g., PTs 129A or 129B) based on a current state (e.g., contained in or not contained in case 122) of foldable mobile device 100, thereby potentially enabling processing circuitry 108 to more accurately configure the radio state (e.g., transmission power level) of radio 112. Through potentially more accurate radio state configuration, foldable mobile device 100 itself may function more efficiently (e.g., in terms of performing wireless communication more reliably with higher signal-to-noise ratios—SNRs, reduced data drops and/or corruption, etc.) and provide a better user experience in terms of more reliable wireless communication, while also adhering to government regulations regarding SARs for wireless communication.

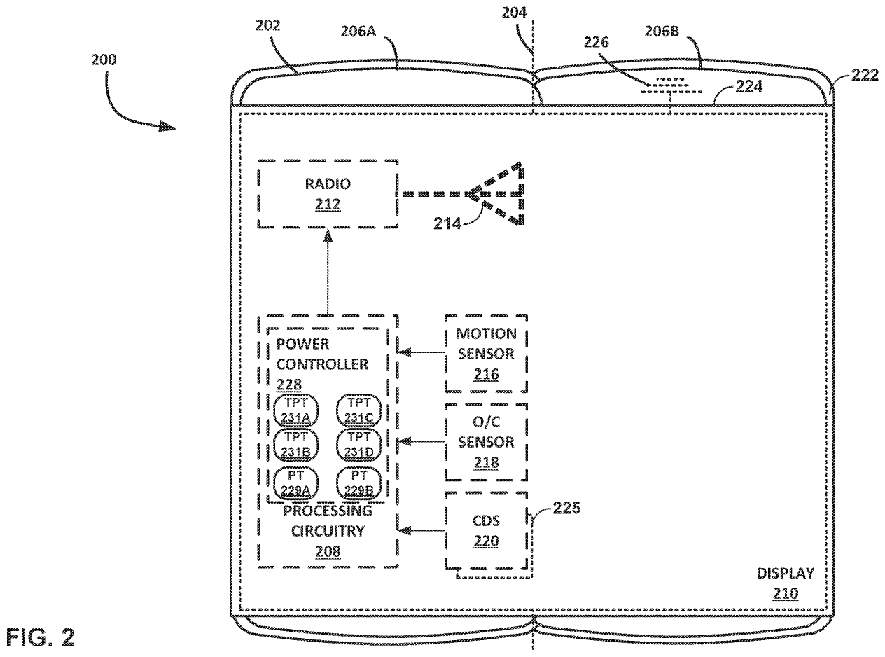

FIG. 2 is a block diagram illustrating another representation of a foldable mobile device in accordance with examples of the present disclosure. Foldable mobile device 200 shown in the example of FIG. 2 may represent another example of foldable mobile device 100 described above. Similar to foldable mobile device 100, foldable mobile device 200 includes a housing 202 having a hinge or other element that enables folding along an axis 204. Foldable mobile device 200 also includes a first half 206A and a second half 206B.

Foldable mobile device 200 further includes, again similar to foldable mobile device 100, processing circuitry 208 configured to implement (e.g., via hardware or a combination of hardware and software-including firmware, middleware, etc.) a power controller 228, a presence-sensitive display 210 (that may operate as a proximity sensor and as such may be referred to as a proximity sensor 210), a radio 212, an antenna 214, and a CDS 220. Each of components 208, 210, 212, 214, 220, and 228 may function in a similar, if not substantially similar manner to that described above with respect to each respective component 108, 110, 112, 114, 120, and 128 except when described below as operating differently.

However, foldable mobile device 200 may differ from foldable mobile device 100 in that foldable mobile device 200 additionally includes a motion sensor 216, and an open/close (O/C) sensor 218 (“O/C sensor 218”). Motion sensor 216 may represent any type of sensor capable of detecting motion with respect to foldable mobile phone 200. Motion sensor 216 may represent one or more of an accelerometer, a gyroscope, a camera, a gravity sensor, a magnetometer, a pedometer and the like. Motion sensor 216 may represent a dedicated sensor or a combination of different sensors that output signals that processing circuitry 208 may be trained (via artificial intelligence and sensor signal fusion) to process in order to identify motion, including gestures in which the user moves foldable mobile device 200.

O/C sensor 218 may represent any type of sensor capable of detecting whether foldable mobile device 200 is in an open state or a closed state (including, in some instances, states in between the open state and the closed state). The open state may refer to when halves 206 are separated and display 210 is fully viewable, while the closed state may refer to when halves 106 are adjacent to one another and display 210 is not fully viewable (or possibly not viewable at all).

O/C sensor 218 may include a hinge sensor displaced along axis 204 or within a hinge mechanism that provides a measure of how halves 206 are arranged relative to one another along axis 204 (e.g., indicating a degree of rotation along axis 204). O/C sensor 218 may, as an alternative or in conjunction with hinge sensor, include a Hall sensor that detects magnetic fields in which case one or both of halves 206 may include a magnet that emits the magnetic field. The Hall sensor may be located proximate to the magnet when closed and thereby identify when halves 206 are proximate to each other (meaning, in the closed state).

In the example of FIG. 2, case detection for setting proximity thresholds is integrated into a more robust process by which to configure radio 212 for various transmission power tables (TPT) 231A-231D (“TPT 231”). Given that foldable mobile device 200 may, in some sizes, transition between a different sizes, such as from smartphone (often a large smartphone, which may be referred to as a phone tablet or “phablet,” and/or miniature tablet) size when in the closed state to a tablet size when in the open state, power controller 228 may first determine whether foldable mobile device 200 is in an open state or a closed state.

To determine whether foldable mobile device 200 is in either the open state or the closed state, power controller 228 may interface with (which again may be interrupt driven via an operating system, through polling, etc.) O/C sensor 216, which may report the open state or the closed state to power controller 228. Responsive to determining the foldable mobile device 200 is in the closed state, power controller 228 may interface with radio 212 to configure either third TPT 231C or fourth TPT 231D as the current transmission power table.

Whether power controller 228 configures radio 212 with either TPT 231C or TPT 231D may depend on whether foldable mobile device 200 is in motion. As such, power controller 228 may interface with motion sensor 216 to determine whether foldable mobile device 200 is in motion. Responsive to determining that the foldable mobile device 200 is in the closed state and that foldable mobile device 200 is not in motion, power controller 228 may interface with radio 212 to configure TPT 231C as the current transmission power table. In this instance, TPT 231C may define a maximum transmission power table (MTPT) for radio 212. Responsive to determining that foldable mobile device 200 is in the closed state and that foldable mobile device 200 is in motion, power controller 228 may configure radio 212 to use TPT 231D, which may define a transmission power table for a miniature tablet or large smartphone SAR.

Responsive to determining that foldable mobile device 200 is in the open state, power controller 228 may determine whether foldable mobile device 200 is in motion (in the manner described above via motion sensor 216. Responsive to determining that the foldable mobile device 200 is in the open state and that foldable mobile device 200 is not in motion, power controller 228 may interface with radio 212 to configure TPT 231C as the current transmission power table.

Responsive to determining that the foldable mobile device 200 is in the open state and that foldable mobile device 200 is in motion, power controller 228 may determine whether foldable mobile device 200 is contained within case 222 in the manner described above with respect to foldable mobile device 100 shown in the example of FIG. 1, setting either PT 229A (which is the same as, or similar to, PT 129A) or PT 229B (which is the same as, or similar to, PT 129B). At this point, power controller 228 may proceed as outlined above to interface with radio 212 to configure either TPT 231A (which is the same as, or similar to, TPT 131A) or TPT 231B (which is the same as, or similar to, TPT 131B). Power controller 228 may continue to monitor the above factors (or, in other words, states of foldable mobile device 200), adjusting radio 212 between TPT 231.

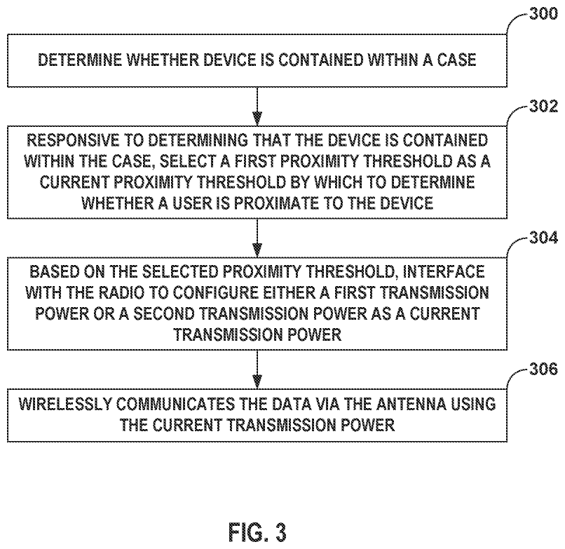

FIG. 3 is a flowchart illustrating example operation of foldable mobile device of FIG. 1 in performing proximity threshold adjustments in accordance with various aspects of the techniques described in this disclosure. As described above, power controller 128 may determine whether foldable mobile device 100 is contained within case 122 (300). That is, power controller 128 may interface with CDS 120 to determine, in one or more of the ways noted above (e.g., magnetic field detection, RFID tag inspection, via sensed capacitance from proximity sensor 110, etc.), whether foldable mobile device 100 is contained within case 122. Responsive to determining that foldable mobile device 100 is contained within case 122, power controller 128 may select a first proximity threshold (PT) 129A (“PT 129A”) as a current proximity threshold by which to determine whether the user is proximate to foldable mobile device 100 (302).

PT 129A may be less than a second proximity threshold, shown as “PT 129B” in the example of FIG. 1, used responsive to determining that foldable mobile device 100 is not contained within case 122. Although described in this example as being less than PT 129B, PT 129A may be greater than PT 129B for different configurations of proximity sensor 110 (e.g., proximity sensors that utilize actual distances, such as radar, etc.). However, in the example of the capacitive sensing proximity sensor described above with respect to presence-sensitive display 110, proximity is defined relative to detected capacitance and case 122 may reduce sensed capacitance resulting in lower PT 129A relative to PT 129B used when case 122 is not detected. In any event, in response to determining that foldable mobile device 100 is not contained within case 122, power controller 128 may select PT 129B as the current proximity threshold.

Based on the selected proximity threshold, power controller 128 may interface with radio 112 to configure either a first transmission power, e.g., TPT 131A, or a second transmission power, e.g., TPT 131B, as a current transmission power (304). That is, power controller 128 may interface (e.g., interrupt driven, periodic polling, etc.) with proximity sensor 110 to determine a current proximity of the user to foldable mobile device 100. Power controller 128 may compare the current proximity to the selected proximity threshold (which, for purposes of example, is assumed to be PT 129A). When the current proximity exceeds the selected proximity threshold, power controller 128 may configure radio 112 to use TPT 131A. When the current proximity does not exceed the selected proximity threshold, power controller 128 may configure radio 112 to use TPT 131B. Radio 112 may then wirelessly communicate data via antenna 114 using the current transmission power (e.g., either TPT 131A or TPT 131B) (306).

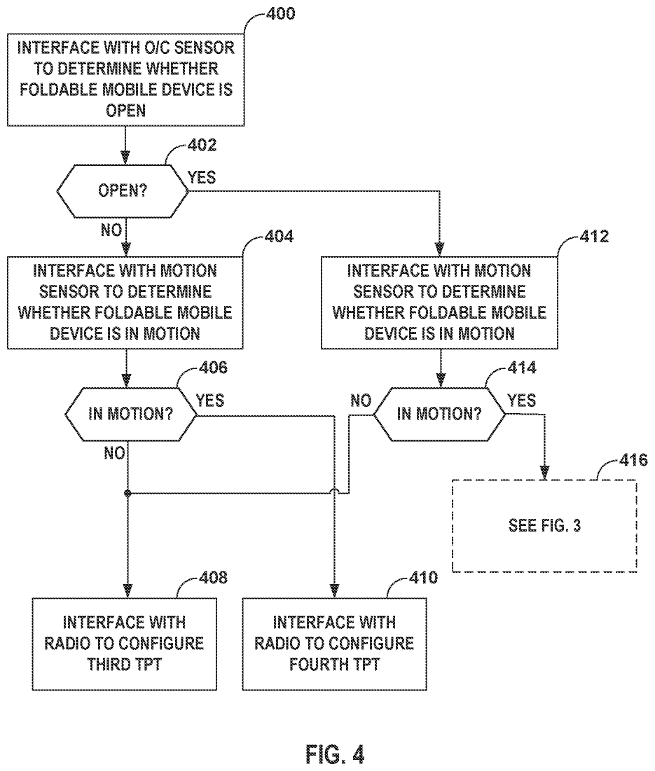

FIG. 4 is a flowchart illustrating example operation of foldable mobile device of FIG. 2 in performing proximity threshold adjustments in accordance with various aspects of the techniques described in this disclosure. In the example of FIG. 4, case detection for setting proximity thresholds is integrated into a more robust process by which to configure radio 212 for various transmission power tables (TPT) 231A-23ID (“TPT 231”). Given that foldable mobile device 200 may, in some sizes, transition between a different sizes, such as from smartphone (often a large smartphone, which may be referred to as a phone tablet or “phablet,” and/or miniature tablet) size when in the closed state to a tablet size when in the open state, power controller 228 may first determine whether foldable mobile device 200 is in an open state or a closed state.

To determine whether foldable mobile device 200 is in either the open state or the closed state, power controller 228 may interface with (which again may be interrupt driven via an operating system, through polling, etc.) O/C sensor 216, which may report the open state or the closed state to power controller 228 and thereby allow power controller 228 to determine whether foldable mobile device 200 is open (400). Responsive to determining the foldable mobile device 200 is in the closed state (“NO” 402), power controller 228 may interface with radio 212 to configure either third TPT 231C or fourth TPT 231D as the current transmission power table.

Whether power controller 228 configures radio 212 with either TPT 231C or TPT 231D may depend on whether foldable mobile device 200 is in motion. As such, power controller 228 may interface with motion sensor 216 to determine whether foldable mobile device 200 is in motion (404). Responsive to determining that the foldable mobile device 200 is in the closed state (“NO” 402) and that foldable mobile device 200 is not in motion (“NO” 406), power controller 228 may interface with radio 212 to configure third TPT 231C as the current transmission power table (408). In this instance, TPT 231C may define a maximum transmission power table (MTPT) for radio 212. Responsive to determining that foldable mobile device 200 is in the closed state (“NO” 402) and that foldable mobile device 200 is in motion (“YES” 406), power controller 228 may configure radio 212 to use fourth TPT 231D (410), which may define a transmission power table for a miniature tablet or large smartphone SAR.

Responsive to determining that foldable mobile device 200 is in the open state (“YES” 402), power controller 228 may determine whether foldable mobile device 200 is in motion (in the manner described above via motion sensor 216) (412). Responsive to determining that the foldable mobile device 200 is in the open state (“YES” 402) and that foldable mobile device 200 is not in motion (“NO” 414), power controller 228 may interface with radio 212 to configure TPT 231C as the current transmission power table (408).

Responsive to determining that the foldable mobile device 200 is in the open state (“YES” 402) and that foldable mobile device 200 is in motion (“YES” 414), power controller 228 may proceed to implement various aspects of the techniques described above with respect to FIG. 3 (416). That is, power controller 228 may determine whether foldable mobile device 200 is contained within case 222 in the manner described above with respect to foldable mobile device 100 shown in the example of FIG. 1, setting either PT 229A (which is the same as, or similar to, PT 129A) or PT 229B (which is the same as, or similar to, PT 129B). At this point, power controller 228 may proceed as outlined above to interface with radio 212 to configure either TPT 231A (which is the same as, or similar to, TPT 131A) or TPT 231B (which is the same as, or similar to, TPT 131B). Power controller 228 may continue to monitor the above factors (or, in other words, states of foldable mobile device 200), adjusting radio 212 between TPT 231.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

In this respect, various aspects of the techniques may enable the following examples.

Example 1. A device comprising: an antenna; a radio configured to wirelessly communicate data via the antenna; and processing circuitry configured to: determine whether the device is contained within a case; responsive to determining that the device is contained within the case, select a first proximity threshold as a current proximity threshold by which to determine whether a user is proximate to the device, the first proximity threshold different than a second proximity threshold used responsive to determining that the device is not contained within the case; and cause, based on the selected proximity threshold, the radio to configure either a first transmission power or a second transmission power as a current transmission power, wherein the radio wirelessly communicates the data via the antenna using the current transmission power.

Example 2. The device of example 1, wherein the processing circuitry is further configured to, responsive to determining that the device is not contained within the case, select the second proximity threshold as the current proximity threshold.

Example 3. The device of example 1, further comprising: a proximity sensor, wherein the processing circuitry is further configured to interface with the proximity sensor to determine a current proximity from the device to a user of the device, wherein, to interface with the radio to configure either the first transmission power or the second transmission power, the processing circuitry is configured to: determine whether the current proximity exceeds the selected proximity threshold; select, responsive to determining that the device is contained within the case and that the current proximity exceeds the current proximity threshold, the first transmission power as the current transmission power; and select, responsive to determining that the device is contained within the case and that the current proximity does not exceed the current proximity threshold, the second transmission power as the current transmission power.

Example 4. The device of example 3, wherein the proximity sensor includes a presence-sensitive display.

Example 5. The device of example 1, wherein the first transmission power includes a first transmission power table that defines one or more transmission powers for a tablet computer having specific absorption rates measured at zero millimeters, and wherein the second transmission power includes a second transmission power table that defines one or more transmission powers for a tablet computer having specific absorption rates measured at the current proximity.

Example 6. The device of claim 1, wherein the device comprises a foldable computing device configured to fold along an axis between a closed state and an open state, and wherein the processing circuitry is further configured to: determine whether the foldable computing device is in the closed state or the open state; and responsive to determining the foldable computing device is in the closed state, cause the radio to configure either a third transmission power or a fourth transmission power as the current transmission power.

Example 7. The device of example 6, wherein the processing circuitry is further configured to determine whether the foldable computing device is in motion, wherein, to interface with the radio to configure either the third transmission power or the fourth transmission power as the current transmission power, the processing circuitry is configured to: responsive to determining that the foldable computing device is in the closed state and that the foldable computing device is not in motion, cause the radio to configure the third transmission power as the current transmission power, wherein the third transmission power includes a third transmission power table that defines a maximum power table for the radio; and responsive to determining that the foldable computing device is in the closed state and that the foldable computing device is in motion, cause the radio to configure the fourth transmission power as the current transmission power, wherein the fourth transmission power includes a fourth transmission power table that defines a transmission power table for a miniature tablet or large smartphone specific absorption rate.

Example 8. The device of example 6, wherein the processing circuitry is further configured to determine whether the device is in motion, and wherein, to cause the radio to configure either the third transmission power or the fourth transmission power as the current transmission power, the processing circuitry is configured to, responsive to determining that the foldable computing device is in the open state and that the foldable computing device is not in motion, cause the radio to configure the third transmission power as the current transmission power table, wherein the third transmission power includes a third transmission power table that defines a maximum power table for the radio, and wherein, to determine whether the foldable computing device is contained within the case, the processing circuitry is configured to, responsive to determining that the foldable computing device is in the open state and that the foldable computing device is in motion, determine whether the device is contained within the case.

Example 9. The device of example 1, further comprising a hall sensor, wherein, to determine whether the device is contained within the case, the processing circuitry is configured to interface with the hall sensor to determine whether the device is contained within the case.

Example 10. The device of example 1, wherein, to determine whether the device is contained within the case, the processing circuitry is configured to determine, based on near field communication, whether the device is contained within the case.

Example 11. The device of example 1, wherein, to determine whether the device is contained within the case, the processing circuitry is configured to determine, based on capacitance detected by a presence-sensitive display, whether the device is contained within the case.

Example 12. The device of example 1, wherein, to determine whether the device is contained within the case, the processing circuitry is configured to: determine whether the case is a valid case that has been tested with respect to the radio with the first power transmission power and the second power transmission power to verify specific absorption rates; and determine, responsive to determining that the case is the valid case, that the device is contained in the valid case.

Example 13. The device of example 1, wherein the device comprises a foldable computing device.

Example 14. A method comprising: determining, by processing circuitry of a device, whether the device is contained within a case; responsive to determining that the device is contained within the case, selecting, by the processing circuitry, a first proximity threshold as a current proximity threshold by which to determine whether a user is proximate to the device, the first proximity threshold different than a second proximity threshold used responsive to determining that the device is not contained within the case; based on the selected proximity threshold, cause, by the processing circuitry, a radio of the device to configure either a first transmission power or a second transmission power as a current transmission power; and wirelessly communicate, by the radio and via an antenna, data using the current transmission power.

Example 15. The method of example 14, further comprising, responsive to determining that the device is not contained within the case, selecting the second proximity threshold as the current proximity threshold.

Example 16. The method of example 14, further comprising: determining, by a proximity sensor, a current proximity from the device to a user of the device, wherein causing the radio to configure either the first transmission power or the second transmission power comprises: determining whether the current proximity exceeds the selected proximity threshold; selecting, responsive to determining that the device is contained within the case and that the current proximity exceeds the current proximity threshold, the first transmission power as the current transmission power; and selecting, responsive to determining that the device is contained within the case and that the current proximity does not exceed the current proximity threshold, the second transmission power as the current transmission power.

Example 17. The method of example 16, wherein the proximity sensor includes a presence-sensitive display.

Example 18. The method of example 14, wherein the first transmission power includes a first transmission power table that defines one or more transmission powers for a tablet computer having specific absorption rates measured at zero millimeters, and wherein the second transmission power includes a second transmission power table that defines one or more transmission powers for a tablet computer having specific absorption rates measured at the current proximity.

Example 19. The method of example 14, wherein determining whether the device is contained within the case comprises: determining whether the case is a valid case that has been tested with respect to the radio with the first power transmission power and the second power transmission power to verify specific absorption rates; and determining, responsive to determining that the case is the valid case, that the device is contained in the valid case.

Example 20. A non-transitory computer-readable storage medium having instructions stored thereon that, when executed, cause one or more processors of a device to:
determine whether the device is contained within a case; select, responsive to determining that the device is contained within the case, a first proximity threshold as a current proximity threshold by which to determine whether a user is proximate to the device, the first proximity threshold different than a second proximity threshold used responsive to determining that the device is not contained within the case; and cause, based on the selected proximity threshold, a radio of the device to configure either a first transmission power or a second transmission power as a current transmission power by which to communicate data via an antenna.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A device comprising:
an antenna;
a radio configured to wirelessly communicate data via the antenna; and
processing circuitry configured to:
determine whether the device is contained within a case;
responsive to determining that the device is contained within the case, select a first proximity threshold as a current proximity threshold by which to determine whether a user is proximate to the device, the first proximity threshold different than a second proximity threshold used responsive to determining that the device is not contained within the case; and
cause, based on the selected proximity threshold, the radio to configure either a first transmission power or a second transmission power as a current transmission power,
wherein the radio wirelessly communicates the data via the antenna using the current transmission power.

2. The device of claim 1, wherein the processing circuitry is further configured to, responsive to determining that the device is not contained within the case, select the second proximity threshold as the current proximity threshold.

3. The device of claim 1 further comprising a proximity sensor,
wherein the processing circuitry is further configured to interface with the proximity sensor to determine a current proximity from the device to a user of the device, and
wherein, to interface with the radio to configure either the first transmission power or the second transmission power, the processing circuitry is configured to:
determine whether the current proximity exceeds the selected proximity threshold;
select, responsive to determining that the device is contained within the case and that the current proximity exceeds the current proximity threshold, the first transmission power as the current transmission power; and
select, responsive to determining that the device is contained within the case and that the current proximity does not exceed the current proximity threshold, the second transmission power as the current transmission power.

4. The device of claim 3, wherein the proximity sensor includes a presence-sensitive display.

5. The device of claim 1,
wherein the first transmission power comprises a first transmission power table that defines one or more transmission powers for a tablet computer having specific absorption rates measured at zero millimeters, and
wherein the second transmission power includes a second transmission power table that defines one or more transmission powers for a tablet computer having specific absorption rates measured at the current proximity.

6. The device of claim 1,
wherein the device comprises a foldable computing device configured to fold along an axis between a closed state and an open state, and
wherein the processing circuitry is further configured to:
determine whether the foldable computing device is in the closed state or the open state; and
responsive to determining the foldable computing device is in the closed state, cause the radio to configure either a third transmission power or a fourth transmission power as the current transmission power.

7. The device of claim 6,
wherein the processing circuitry is further configured to determine whether the foldable computing device is in motion, and
wherein, to interface with the radio to configure either the third transmission power or the fourth transmission power as the current transmission power, the processing circuitry is configured to:
responsive to determining that the foldable computing device is in the closed state and that the foldable computing device is not in motion, cause the radio to configure the third transmission power as the current transmission power, wherein the third transmission power includes a third transmission power table that defines a maximum power table for the radio; and
responsive to determining that the foldable computing device is in the closed state and that the foldable computing device is in motion, cause the radio to configure the fourth transmission power as the current transmission power, wherein the fourth transmission power includes a fourth transmission power table that defines a transmission power table for a miniature tablet or large smartphone specific absorption rate.

8. The device of claim 6,
wherein the processing circuitry is further configured to determine whether the device is in motion, and
wherein, to cause the radio to configure either the third transmission power or the fourth transmission power as the transmission power, the processing circuitry is configured to, responsive to determining that the foldable computing device is in the open state and that the foldable computing device is not in motion, cause the radio to configure the third transmission power as the current transmission power, wherein the third transmission power includes a third transmission power table that defines a maximum power table for the radio, and
wherein, to determine whether the foldable computing device is contained within the case, the processing circuitry is configured to, responsive to determining that the foldable computing device is in the open state and that the foldable computing device is in motion, determine whether the device is contained within the case.

9. The device of claim 1, further comprising a hall sensor,
wherein, to determine whether the device is contained within the case, the processing circuitry is configured to interface with the hall sensor to determine whether the device is contained within the case.

10. The device of claim 1, wherein, to determine whether the device is contained within the case, the processing circuitry is configured to determine, based on radio frequency identification, whether the device is contained within the case.

11. The device of claim 1, wherein, to determine whether the device is contained within the case, the processing circuitry is configured to determine, based on capacitance detected by a presence-sensitive display, whether the device is contained within the case.

12. The device of claim 1, wherein, to determine whether the device is contained within the case, the processing circuitry is configured to:
determine whether the case is a valid case that has been tested with respect to the radio with the first power transmission power and the second power transmission power to verify specific absorption rates; and
determine, responsive to determining that the case is the valid case, that the device is contained in the valid case.

13. The device of claim 1, wherein the device comprises a foldable computing device.

14. A method comprising:
determining, by processing circuitry of a device, whether the device is contained within a case;
responsive to determining that the device is contained within the case, selecting, by the processing circuitry, a first proximity threshold as a current proximity threshold by which to determine whether a user is proximate to the device, the first proximity threshold different than a second proximity threshold used responsive to determining that the device is not contained within the case;
based on the selected proximity threshold, cause, by the processing circuitry, a radio of the device to configure either a first transmission power or a second transmission power as a current transmission power; and
wirelessly communicate, by the radio and via an antenna, data using the current transmission power.

15. The method of claim 14, further comprising, responsive to determining that the device is not contained within the case, selecting the second proximity threshold as the current proximity threshold.

16. The method of claim 14, further comprising:
determining, by a proximity sensor, a current proximity from the device to a user of the device,
wherein causing the radio to configure either the first transmission power or the second transmission power comprises:
determining whether the current proximity exceeds the selected proximity threshold;
selecting, responsive to determining that the device is contained within the case and that the current proximity exceeds the current proximity threshold, the first transmission power as the current transmission power; and
selecting, responsive to determining that the device is contained within the case and that the current proximity does not exceed the current proximity threshold, the second transmission power as the current transmission power.

17. The method of claim 16, wherein the proximity sensor includes a presence-sensitive display.

18. The method of claim 14,
wherein the first transmission power includes a first transmission power table that defines one or more transmission powers for a tablet computer having specific absorption rates measured at zero millimeters, and
wherein the second transmission power includes a second transmission power table that defines one or more transmission powers for a tablet computer having specific absorption rates measured at the current proximity.

19. The method of claim 14, wherein determining whether the device is contained within the case comprises:
determining whether the case is a valid case that has been tested with respect to the radio with the first power transmission power and the second power transmission power to verify specific absorption rates; and
determining, responsive to determining that the case is the valid case, that the device is contained in the valid case.

20. A non-transitory computer-readable storage medium having instructions stored thereon that, when executed, cause one or more processors of a device to:
determine whether the device is contained within a case;
select, responsive to determining that the device is contained within the case, a first proximity threshold as a current proximity threshold by which to determine whether a user is proximate to the device, the first proximity threshold different than a second proximity threshold used responsive to determining that the device is not contained within the case; and
cause, based on the selected proximity threshold, a radio of the device to configure either a first transmission power or a second transmission power as a current transmission power table by which to communicate data via an antenna.
